(19) United States
(12) Patent Application Publication
(10) Pub. No.: US 2020/0240290 A1
(43) Pub. Date: Jul. 30, 2020

(54) ENGINE COMPONENT WITH AT LEAST ONE COOLING CHANNEL AND METHOD OF MANUFACTURING

(71) Applicant: Rolls-Royce Deutschland Ltd & Co KG, Blankenfelde-Mahlow (DE)

(72) Inventors: Kay HEINZE, Ludwigsfelde (DE); Miklos GERENDAS, Am Mellensee (DE)

(21) Appl. No.: 16/747,209

(22) Filed: Jan. 20, 2020

(30) Foreign Application Priority Data
Jan. 25, 2019 (DE) 10 2019 200 985.9

(51) Int. Cl. F01D 25/12

(52) U.S. Cl. CPC F01D 25/12; F05D 2230/00

(57) ABSTRACT

The present invention relates, in particular, to an engine component, having at least one cooling duct, which extends from an inlet opening on a first side of the engine component to an outlet opening on a second side of the engine component through the engine component.

A second, inner duct wall of the cooling duct has a recess relative to an opposite first, outer duct wall in a region of the cooling duct situated between the inlet opening and the outlet opening, said recess being of V-shaped design in a cross-sectional view through the cooling duct and in a direction of view along a direction of extent of the cooling duct.

This application claims priority to German Patent Application DE102019200985.9 filed Jan. 25, 2019, the entirety of which is incorporated by reference herein.

The invention relates to an engine component having at least one cooling duct and to a production method.

Engine components, especially those for a combustion chamber of an engine, are generally provided with a multiplicity of cooling holes in order to protect the respective engine component from the hot combustion space of the combustion chamber by appropriate cooling. Thus, for example, there is a known practice of providing (effusion) cooling holes in engine components such as heat shields, combustion chamber shingles or even combustion chamber walls. Here, a corresponding cooling hole always extends through the engine component from an inlet opening on a first side of the respective engine component to an outlet opening on a second side of the engine component.

Particularly in the case of (effusion) cooling holes of small cross section, the cross section and course of the cooling hole extending in the manner of a duct through the engine component are decisive for enabling a sufficient quantity of air for cooling to be used effectively. In this context, widely differing geometries for corresponding cooling holes designed as cooling ducts are proposed in US 2016/0097285 A1 and US 2017/176006 A1, for example. In particular, consideration has already been given in this context to providing a cooling hole with a varying cross section and/or with a deflecting region for deflecting the cooling air in the course of its extent from the inlet opening to the outlet opening.

Particularly in the case of cooling ducts provided with a deflecting region which are produced in the course of an additive manufacturing process, the problem can arise that the duct walls cannot be produced in an optimum manner in the deflecting region, in which a deflection of the fluid passed through the cooling duct is achieved. Particularly in the case of a deflection of the fluid in the cooling duct by more than 90°, it can happen, for example, that partially unmelted powder remains on an inner duct wall of the cooling duct during additive manufacture, especially during manufacture by laser sintering. At a corresponding inner duct wall of a deflecting region, said wall having a convex curvature for example, the cooling duct is therefore not of optimum design, and, as a result, not only the throughflow but also the mechanical integrity of the cooling duct can be negatively affected. Comparable problems may also occur with additively manufactured cooling ducts which are rectilinear and therefore do not deflect the fluid carried therein.

Consequently, there is a need for engine components that are improved in this respect and for production methods that are improved in this respect.

The proposed solution provides a remedy here with an engine component according to Claim 1 and a production method according to Claim 12.

In this case, the proposal is for an engine component having at least one cooling duct, which
extends from an inlet opening on a first side of the engine component to an outlet opening on a second side of the engine component through the engine component, wherein fluid flowing into the cooling duct (11) along an inflow direction (Ra) at the inlet opening (11a) can flow out along an outflow direction (Rb) at the outlet opening (11b), and
has a first, outer duct wall, which lies in the direction of the inflow direction, and a second, inner duct wall, which lies opposite the first, outer duct wall in a cross-sectional view through the engine component and in a direction of view transverse to the inflow and outflow directions.

The second, inner duct wall has a recess relative to the first, outer duct wall in a region of the cooling duct situated between the inlet opening and the outlet opening, said recess being of V-shaped design in a cross-sectional view through the cooling duct and in a direction of view along a direction of extent of the cooling duct.

In this case, the cooling duct can in principle be rectilinear, e.g. in the form of a cylindrical through-opening. However, it is also possible, in particular, for the cooling duct to deflect a fluid flowing in at the inlet opening in a deflecting region along its length in such a way to the outlet opening that the fluid flows out along the outflow direction at the outlet opening with a direction component which is opposite to a direction component of the inflow direction along which the fluid flows into the cooling duct at the inlet opening. The cross-sectional view through the engine component and in a direction of view transverse to the inflow and outflow directions then shows the deflecting course of the cooling duct from the inlet opening to the outlet opening. The second, inner duct wall then has the recess relative to the first, outer duct wall precisely in the deflecting region of the cooling duct situated between the inlet opening and the outlet opening, said recess being of V-shaped design in the cross-sectional view.

This variant embodiment thus proceeds from the basic concept of forming a recess that is V-shaped in a cross-sectional view precisely in a second, inner duct wall, in a deflecting region of the cooling duct, in which that point in the flow profile of the fluid passed through the cooling duct at which a direction vector of the fluid flow changes sign is situated. By means of this recess, a flow cross section of the cooling duct is enlarged locally in the deflecting region but, at the same time, this may, for example, then be independent of a geometry of the flow cross section which also changes (continuously) in the direction of the outlet opening, outside the deflecting region. Thus, an enlargement, defined by the recess, of the flow cross section is superposed only locally on a larger-scale change in the geometry of the flow cross section in the direction of the outlet opening, for example. In this case, the recess of V-shaped cross section can, in principle, be of elongate design and its shape (in the deflecting region) can follow the direction of extent of the cooling duct.

While any large-scale change in the geometry of the flow cross section serves primarily to ensure that the cooling duct influences the fluid flow in a certain way, the proposed formation of a V-shaped recess in the inner duct wall in the cross-sectional view through the cooling duct aims primarily at improved suitability for manufacture of the engine component and of the cooling duct of said component. Thus, it has been found that an appropriate recess geometry, particularly in the inner duct wall of the cooling duct, in a deflecting region, makes it possible to avoid unwanted, partially unmelted powder residues during additive manufacture of the engine component, e.g. in the course of laser sintering. However, such powder residues are often associated with a reduction in the flow cross section and hence with reduced cooling effectiveness as well as a nonspecific deviation from the specified contour of the flow cross section. With the recess geometry proposed, such disadvantages can be reduced or even completely avoided. By specifying the specific recess geometry proposed, it is also easily possible to reproduce the advantages explained above.

For example, one variant embodiment envisages that two wall portions of the second, inner duct wall, which define two legs of the V-shaped recess in the cross-sectional view through the cooling duct, enclose between them an angle (of spread) which is greater than or equal to 60°. By means of the appropriate angle, the opening width of the recess is thus characterized more specifically.

Particularly with a view to creating a self-supporting structure during manufacture of the inner duct wall with the recess, it may be advantageous in one possible development for the two wall portions of the second, inner duct wall to enclose between them an angle in a range of from 60 to 150°, in particular in a range of from 70° to 120°, 76° to 110° or 84° to 94°. For example, one variant embodiment envisages an angle of 90° between the two wall portions which define the V-shaped recess in the second, inner duct wall in the cross-sectional view through the cooling duct. Here, an appropriate orientation of the two wall portions relative to one another can assist self-support of the wall portions during the layered buildup.

Particularly with a view to specifying specific parameters for the creation of the engine component in the course of additive manufacture, a definition of the course of a wall portion of the second, inner duct wall for the formation of a recess geometry in accordance with the proposed solution has furthermore proven to be easily manageable as an alternative or supplementary measure. In this case, reliance is once again placed on two wall portions of the second, inner duct wall, which each define one of two legs of the V-shaped recess in the cross-sectional view through the cooling duct. In a cross-sectional view through the cooling duct, in the region having the recess, at least one of these two wall portions extends at a buildup angle greater than or equal to 15° to a centerline of the cooling duct, with respect to which a base flow cross section of the cooling duct which does not have the recess is formed in mirror symmetry in the region having the recess. Here, the recess represents a local variation in the base flow cross section with which the cooling duct extends in the region having the recess, e.g. in a deflecting region. For example, a base flow cross section of this kind is circular, oval or rectangular. Thus, the recess, which is V-shaped in the cross-sectional view, locally widens a base flow cross section of this kind by the V shape. In this configuration, the recess represents a local change in the corresponding peripheral contour of the base flow cross section in the second, inner duct wall. The virtual centerline or axis of symmetry of this base flow cross section is then selected as a reference line in order to specify the buildup angle at which one or more of the wall portions must extend relative to the centerline for the correct formation of the recess geometry.

For example, at least one of the two wall portions extends at a buildup angle in a range of from 15° to 60°, in particular in a range of from 30° to 55°, 35° to 52° or 43° to 48°, to the centerline in the cross-sectional view through the cooling duct. For example, at least one of the two wall portions can extend at a buildup angle of 45° to the centerline in the cross-sectional view through the cooling duct.

Of course, provision can be made for the cooling duct to have a flow cross section which—based on a direction of extent from the inlet opening to the outlet opening—corresponds to the base flow cross section before and/or after the region having the recess.

In one illustrative embodiment, the proposed solution is employed in the case of an engine component, the cooling duct of which provides an entry angle α for the fluid flow which is greater than or equal to 70° and an exit angle β at the outlet opening which is greater than or equal to 70°. In each case based on a mathematically positive direction of rotation, in the cross-sectional view through the engine component and in a direction of view transverse to the inflow and outflow directions, the inflow direction extends at an (acute) angle α≥70° to a boundary, bounding the inlet opening, of the first side of the engine component, and hence at a corresponding angle α≥70° to a plane in which the inlet opening lies. A boundary, bounding the outlet opening, of the second side of the engine component and thus a plane in which the outlet opening lies likewise extends at an (acute) exit angle β≥70° to the outflow direction.

In principle, the proposed engine component can be a component of a combustion chamber of an engine, for example. In particular, the engine component can be a heat shield, a combustion chamber shingle or a combustion chamber wall. For example, one illustrative embodiment envisages that the engine component is formed by a combustion chamber shingle, in particular by an additively manufactured combustion chamber shingle for an engine combustion chamber or a fixed gas turbine combustion chamber.

Another aspect of the proposed solution relates to a method for the additive manufacture of an engine component having a cooling duct. Here, one method proposed can comprise the production of the engine component by laser sintering, for example.

It is envisaged that the engine component is built up in layers in a buildup direction with a cooling duct which
extends from an inlet opening on a first side of the engine component to an outlet opening on a second side of the engine component through the engine component, wherein fluid flowing into the cooling duct along an inflow direction at the inlet opening can flow out along an outflow direction at the outlet opening, and
a first, outer duct wall, which lies in the direction of the inflow direction, and a second, inner duct wall, which lies opposite the first, outer duct wall in a cross-sectional view through the engine component and in a direction of view transverse to the buildup direction, is to be produced.

The second, inner duct wall is formed with a recess relative to the first, outer duct wall in a region of the cooling duct situated between the inlet opening and the outlet opening, said recess being of V-shaped design in a cross-sectional view through the cooling duct and in a direction of view along a direction of extent of the cooling duct.

In the case where the engine component to be formed with the cooling duct is built up in layers, a recess which is V-shaped in the cross-sectional view through the cooling duct is thus provided in the region (e.g. central region) of the cooling duct and here in the inner, second duct wall, which lies opposite the first, outer duct wall, which will lie in the direction of the subsequent inflow direction. Here, the proposed V shape in the relevant cross-sectional view has the advantage, for example, that the probability of partially unmelted powder residues in a laser sintering process can be avoided or at least reduced to a degree which is not disruptive, precisely at the inner duct wall. It is thereby also possible to exert a positive influence on the mechanical integrity of the cooling wall structure to be produced.

In particular, it is possible for the cooling duct to deflect a fluid flowing in at the inlet opening in a deflecting region along its length in such a way to the outlet opening that the fluid flows out along the outflow direction at the outlet opening with a direction component which is opposite to a direction component of the inflow direction along which the fluid flows into the cooling duct at the inlet opening. The cross-sectional view through the engine component and in a direction of view transverse to the inflow and outflow directions then shows the deflecting course of the cooling duct from the inlet opening to the outlet opening. The second, inner duct wall is then formed with the recess relative to the first, outer duct wall precisely in the deflecting region of the cooling duct situated between the inlet opening and the outlet opening, said recess being of V-shaped design.

In one variant embodiment, the wall portions of the second, inner duct wall, which form the recess to be produced, are embodied in such a way as to be self-supporting during the buildup of the engine component, for example. Depending, in particular, on the material used and the type of additive manufacturing method employed, the wall portions of the second, inner duct wall which form the recess thus remain true to shape, even without a supporting structure, and have a certain (inherent) stability, with the result that they retain the structure built up in layers without further measures, even if the second, inner duct wall of the cooling duct has not yet been completely produced.

This is advantageous particularly if the second, inner duct wall is situated above the first, outer duct wall in the buildup direction and is therefore built up fully only after the first, outer duct wall during the additive manufacture of the engine component. Thus, based on the buildup direction, a region having the recess in the second, inner duct wall is built up while forming an overhang during the additive manufacture of the engine component. Here, the statement that the second, inner duct wall is situated above the first, outer duct wall in the buildup direction does not refer to an orientation of the engine component in its correct installation position but to the orientation during the layered buildup of the component, e.g. on a base plate of a 3-D printer.

In one variant embodiment, a buildup angle is furthermore specified which, in a reference plane extending parallel to the buildup direction (and lying in the cross-sectional view through the cooling duct), is enclosed between a centerline extending transversely to the buildup direction and a wall portion, to be produced, of the second, inner duct wall, which is intended to form one leg of the V-shaped recess in the cross-sectional view through the duct wall. The wall portion to be produced is then built up in a computer-assisted manner in such a way that the wall portion extends at a buildup angle greater than or equal to 15° to the centerline. This includes, in particular, the situation where the wall portion extends at a buildup angle in a range of from 15° to 60°, in particular in a range of from 30° to 55°, 35° to 52° or 43° to 48°, to the centerline. A buildup angle of 45° is provided, for example.

In this case, the centerline of the cooling duct to be produced can be defined by a virtual line with respect to which an unrecessed base flow cross section of the cooling duct is formed in mirror symmetry in the deflecting region. Consequently, if the V-shaped contour of the recess is imagined to be absent in the cross-sectional view, the base flow cross section is obtained, which is built up in mirror symmetry with respect to the centerline and, for example, is circular, oval or rectangular.

The engine component to be produced can be, in particular, a combustion chamber shingle, for example.

A production method proposed furthermore also enables a proposed engine component to be produced, and therefore advantages and features explained above and below for variant embodiments of a proposed engine component also apply to variant embodiments of a proposed production method and vice versa.

The appended figures illustrate, by way of example, possible design variants of the proposed solution.

In the figures:

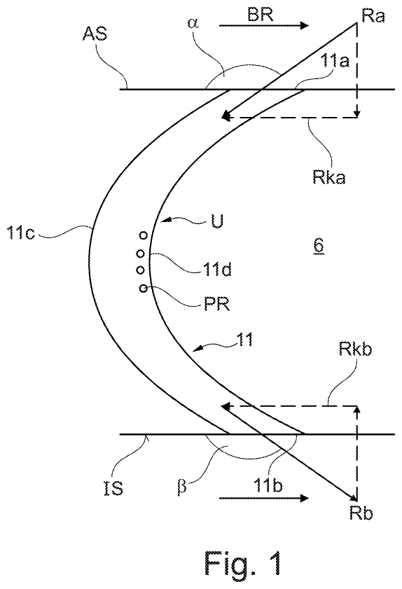

FIG. 1 shows a segment of an engine component in a cross-sectional view through the engine component and in a direction of view transverse to the inflow and outflow directions of a fluid carried in a cooling duct of the engine component;

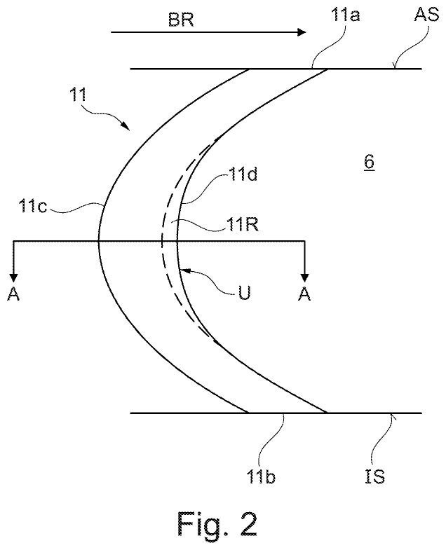

FIG. 2 shows the engine component in a view that corresponds to FIG. 1, illustrating a buildup direction for the additive manufacture, in layers, of the engine component and of an elongate recess in a second, inner duct wall of the cooling duct;

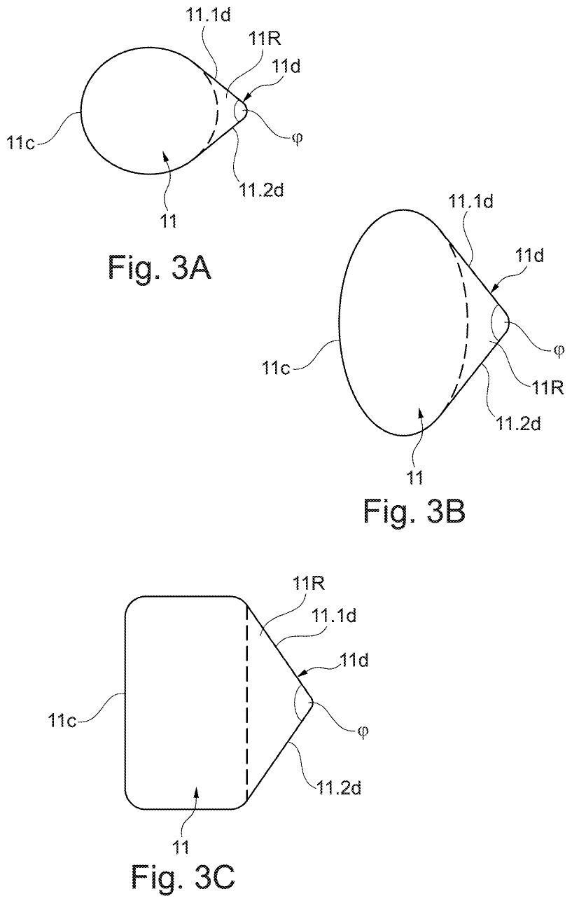

FIGS. 3A-3C show, in a cross-sectional view, defined in accordance with a reference plane A-A in FIG. 2, through the cooling duct in FIG. 2 and in a direction of view along a direction of extent of the cooling duct, different cross sections of the cooling duct, which are each defined by a base flow cross section and a recess of V-shaped cross section positioned adjacent thereto;

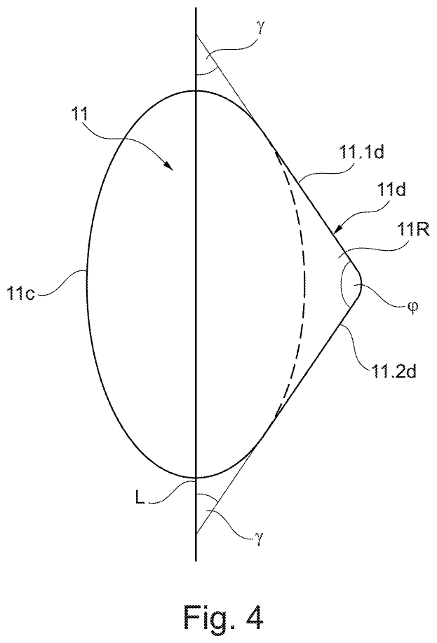

FIG. 4 shows an enlarged illustration of the cross section of FIG. 3B, illustrating a buildup angle for the specification of a profile of a wall portion of the inner duct wall which defines one leg of the V shape of the recess;

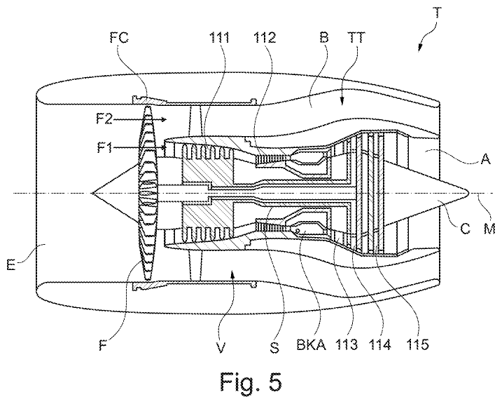

FIG. 5 shows an engine in which an engine component corresponding to FIGS. 1 to 4 is used;

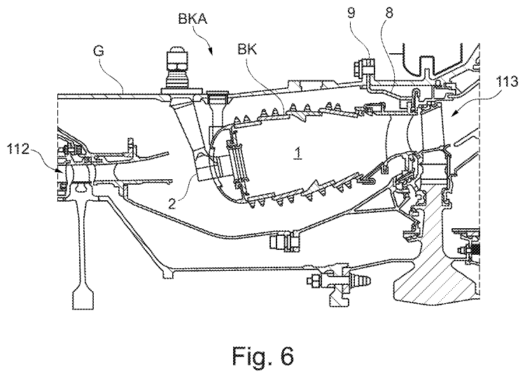

FIG. 6 shows, on an enlarged scale, a segment of a combustion chamber of the engine of FIG. 5;

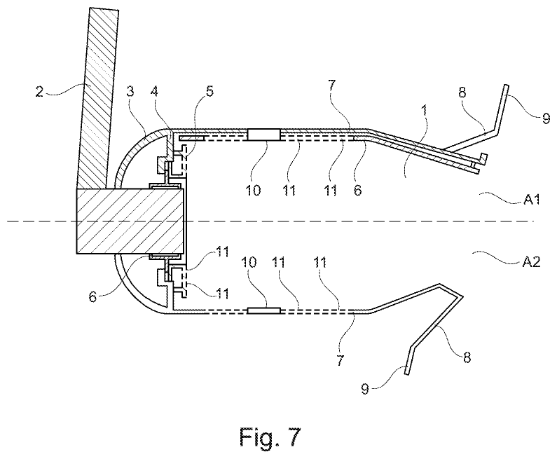

FIG. 7 shows in cross-sectional view the fundamental structure of a combustion chamber, again on an enlarged scale in comparison with FIG. 6.

FIG. 5 illustrates, schematically and in a sectional illustration, a (turbofan) engine T in which the individual engine components are arranged one behind the other along an axis of rotation or central axis M, and the engine T is formed as a turbofan engine. At an inlet or intake E of the engine T, air is drawn in along an inlet direction by means of a fan F. This fan F, which is arranged in a fan casing FC, is driven by means of a rotor shaft S which is set in rotation by a turbine TT of the engine T. Here, the turbine TT adjoins a compressor V, which comprises for example a low-pressure compressor 111 and a high-pressure compressor 112, and possibly also a medium-pressure compressor. The fan F on one side conducts air in a primary air flow F1 to the compressor V, and on the other side, to generate thrust, in a secondary air flow F2 to a secondary flow duct or bypass duct B. The bypass duct B here runs around a core engine comprising the compressor V and the turbine TT and comprising a primary flow duct for the air supplied to the core engine by the fan F.

The air conveyed into the primary flow duct by means of the compressor V passes into a combustion chamber portion BKA of the core engine, in which the drive energy for driving the turbine TT is generated. For this purpose, the turbine TT has a high-pressure turbine 113, a medium-pressure turbine 114 and a low-pressure turbine 115. Here, the energy released during the combustion is used by the turbine TT to drive the rotor shaft S and thus the fan F in order to generate the required thrust by means of the air conveyed into the bypass duct B. Both the air from the bypass duct B and the exhaust gases from the primary flow duct of the core engine flow out via an outlet A at the end of the engine T. In this arrangement, the outlet A generally has a thrust nozzle with a centrally arranged outlet cone C.

In principle, the fan F may also be coupled via a connecting shaft and an epicyclic planetary transmission to the low-pressure turbine 115, and be driven by the latter. It is furthermore also possible to provide other, differently designed gas turbine engines in which the proposed solution can be used. For example, such engines may have an alternative number of compressors and/or turbines and/or an alternative number of connecting shafts. As an example, the engine may have a split-flow nozzle, meaning that the flow through the bypass duct B has its own nozzle, which is separate from and situated radially outside the core engine nozzle. However, this is not limiting, and any aspect of the present disclosure may also apply to engines in which the flow through the bypass duct B and the flow through the core are mixed or combined before (or upstream of) a single nozzle, which may be referred to as a mixed-flow nozzle. One or both nozzles (whether mixed or split flow) can have a fixed or variable area. While the example described relates to a turbofan engine, the proposed solution may be applied for example to any type of gas turbine engine, such as an open-rotor engine (in which the fan stage is not surrounded by an engine nacelle) or a turboprop engine.

FIG. 6 shows a longitudinal section through the combustion chamber portion BKA of the engine T. This shows in particular an (annular) combustion chamber BK of the engine T. A nozzle assembly is provided for the injection of fuel or an air-fuel mixture into a combustion space 1 of the combustion chamber BK. Said nozzle assembly comprises a combustion chamber ring, on which multiple fuel nozzles 2 are arranged along a circular line around the central axis M. Here, on the combustion chamber ring, there are provided the nozzle outlet openings of the respective fuel nozzles 2 which are situated within the combustion chamber BK. Here, each fuel nozzle 2 comprises a flange by means of which a fuel nozzle 2 is screwed to an outer casing G of the combustion chamber portion BKA.

FIG. 7 shows, again on an enlarged scale in comparison with FIG. 6 and in section the combustion chamber BK in two different variants A1 and A2. Here, the combustion chamber BK is held on the casing G by means of an arm 8 and a flange 9. In this case, the combustion chamber BK has a combustion space 1 in a manner known per se. In this case, as illustrated in the upper half as an alternative A1 in FIG. 7, the combustion chamber BK can be embodied with a double wall having a combustion chamber wall 7 and combustion chamber shingles 6, or, as illustrated in the bottom half as an alternative A2 in FIG. 7, can be of single-walled design. The combustion chamber wall 7 and/or the combustion chamber shingles 6 are formed with mixing holes 10 and effusion cooling holes 11 in order to cool the combustion chamber wall 7 and/or the combustion chamber shingles 6 and thus protect them from the combustion space 1, which is hot during the operation of the engine T.

A combustion chamber head 3 having a head plate 4 is provided at the front end of the combustion chamber BK. The fuel nozzle 3 is inserted through a corresponding through-opening in the head plate 4 and in the combustion chamber head 3, thus enabling a fuel-air mixture to be introduced into the combustion space 1 via the fuel nozzle 2. In the region of the fuel nozzle 2, a heat shield 5 is mounted on the head plate 4 from the inside of the combustion space 1, likewise as protection from heat generated in the combustion space 1. In this arrangement, the heat shield 5 also has effusion cooling holes 11 for cooling.

According to one variant embodiment of the proposed solution, in order to make effective use of the air quantity available for cooling and to improve production, it is now proposed to design the cooling holes 11 in an engine component, such as the heat shield 5, the combustion chamber shingle 6 or the combustion chamber wall 7, as a cooling duct with a geometry in which an inner duct wall has a recess relative to an opposite outer duct wall in a deflecting region of the cooling duct 11, which is situated between the inlet opening and the outlet opening and which is of V-shaped design in a cross-sectional view through the cooling duct 11 and over the direction of view along a direction of extent of the cooling duct 11.

Here, FIG. 1 first of all shows, by way of example, a combustion chamber shingle 6, on which one variant embodiment of the proposed solution is based. In this case, the combustion chamber shingle 6 has an arc-shaped profile in the cross-sectional view of FIG. 1 through the combustion chamber shingle 6 and in a direction of view transverse to the inflow and outflow directions Ra and Rb. The cooling duct 11 extends from an inlet opening 11a on an outer side AS of the combustion chamber shingle 6 to an outlet opening 11b on an inner side IS of the combustion chamber shingle 6. Over the course of an approximately centrally arranged deflecting region U of the cooling duct 11, a fluid flowing in at the inlet opening 11a is deflected to the outlet opening 11b in such a way that the fluid flows out along the outflow direction Rb at the outlet opening 11b with a direction component Rkb which is opposite to a direction component Rka of the inflow direction Ra along which the fluid flows into the cooling duct 11 at the inlet opening 11a. Here, the fluid flows into the cooling duct 11 along the inflow direction Ra at an acute entry angle α≥70° and flows out of the cooling duct 11 along the outflow direction Rb at an acute exit angle β≥70°. If the inflow and outflow directions Ra, Rb are each understood as a vector composed of two mutually perpendicular direction vectors, at least one direction vector for the direction components Rka, Rkb changes sign over the deflecting region, with the result that the fluid flows out at the outlet opening 11b with a direction component RKb that is opposite to the direction component Rka of the inflow direction Ra.

In the cross-sectional view in FIG. 1, the cooling duct 11 has two mutually opposite duct walls 11c, 11d. In this case, a first, outer duct wall 11c (visible on the left in the cross-sectional view in FIG. 1), which is situated in the direction of the inflow direction Ra, lies opposite a second, inner duct wall 11b (on the right in FIG. 1). In relation to a buildup direction BR of the combustion chamber shingle 6, the first, outer duct wall 11c is below the second, inner duct wall 11d. Here, the buildup direction BR indicates the direction along which the combustion chamber shingle 6 is built up in layers on a base plate, e.g. a base plate of a 3-D printer, in the context of an additive manufacturing process, e.g. in the course of laser sintering.

In the deflecting region U, the inner duct wall 11d has a convex curvature in the direction of the outer duct wall 11c in the cross-sectional view in FIG. 1. Such a geometry can have the effect that unmelted powder residues PR remain in the deflecting region U owing to the overhang which is present on the inner duct wall 11d during the layered buildup of the combustion chamber shingle 6. Under some circumstances, such unmelted powder residues PR lead to a reduction in a cross-sectional area of flow and hence to reduced cooling effectiveness in the combustion chamber shingle 6 produced. This can also result in a geometrically undefined cooling duct geometry, thereby impairing the dispersion of a cooling air mass flow and/or the mechanical integrity of the inner duct wall 11d.

In this respect, the proposed solution provides a remedy, one illustrative embodiment of which is illustrated in FIG. 2 in a view that corresponds to FIG. 1.

Here, in the case of the variant embodiment in FIG. 2, the inner duct wall 11d is formed with an elongate recess 11R in the deflecting region U. By virtue of this defined recess 11R, an accumulation of unmelted powder residues on the bulging duct wall 11d is very largely excluded during the additive manufacture of the combustion chamber shingle 6. By virtue of the recess 11R, the cooling duct design is modified in the region of the overhang at the inner duct wall 11d, and the surface of the inner duct wall 11d is set back in comparison with the initial geometry of FIG. 1.

Here, the recess 11R is of V-shaped configuration in a cross-sectional view through the cooling duct 11 according to the reference plane A-A in FIG. 2 in the direction of view along the cooling duct 11. By virtue of this V shape of the recess 11R, the wall portions 11.1d, 11.2d of the inner duct wall 11d which define the V shape can be of self-supporting design and hence form a self-supporting structure. During the additive manufacture of the combustion chamber shingle 6, the inner duct wall 11d thus remains true to shape and has adequate stability. During the production process, there is therefore no risk of a wall portion 11.1d or 11.2d of the inner duct wall 11d collapsing.

In principle, provision can be made, in a development, for a flow cross section of the cooling duct 11 to vary along its course from the inlet opening 11a to the outlet opening 11b. The cooling duct 11, in particular, can be designed to compensate the recess 11R at least locally enlarging the flow cross section in the region of the recess 11R with a smaller diameter.

Illustrative cross sections of the cooling duct 11 in the deflecting region U having the recess 11R are shown in FIGS. 3A, 3B and 3C.

In the variant embodiment in FIG. 3A, the cooling duct 11 is formed with a circular base flow cross section. Here, the V-shaped recess 11R thus forms a lateral extension to the circular base flow cross section in the cross-sectional view, by means of which extension the flow cross section is enlarged. The two wall portions 11.1d and 11.2d defining the V shape of the recess 11R enclose between them an angle φ (of spread) in a range of from 60° to 150°. In the illustrative embodiment in FIG. 3A, the angle φ between the two wall portions 11.1d and 11.2d is in the region of or exactly 90°, for example.

In the case of the cross-sectional views in FIGS. 3B and 3C, the starting point is a cooling duct 11 with an oval or a rectangular base flow cross section. In the variant embodiment shown in FIG. 3B, an oval base flow cross section of the cooling duct 11 is provided, while, in the variant embodiment shown in FIG. 3C, a rectangular base flow cross section of the cooling duct 11 is provided. Here, the extension formed laterally by the recess 11R has two wall portions 11.1d and 11.2d of the inner duct wall 11d, which enclose between them an angle φ in the region of 110°.

Before and after the deflecting region U with the elongate recess 11R (and therefore above and below the deflecting region U in the figure), the cooling duct 11 has the respective base flow cross section, i.e. a circular base flow cross section in the variant embodiment in FIG. 3A, an oval base flow cross section in the variant embodiment in FIG. 3B and a rectangular base flow cross section in the variant embodiment in FIG. 3C, for example.

As already explained, it is possible, in particular, for disruptive unmelted powder residues PR on the inner duct wall 11d in the deflecting region U to be avoided during the additive manufacture of the combustion chamber shingle 6 by means of the recess 11R defined by the wall portions 11.1d and 11.2d, which intersect at a right angle or at an obtuse angle, if the combustion chamber shingle 6 is produced by laser sintering. Depending on the material used and the production method, it may also be possible by this means, during the layered buildup of the combustion chamber shingle 6 along the buildup direction BR, for the wall portions 11.1d and 11.2d to form a self-supporting structure which has adequate inherent stiffness without a supporting structure and, accordingly, remains in the desired shape until the inner duct wall 11d has been fully built up.

With a view to computer-assisted production of the combustion chamber shingle 6, it may furthermore be appropriate to define the profile of the wall portions 11.1d and 11.2d not only by way of the angle φ (of spread) but also in some other way, namely with (greater) reference to the base flow cross section. Thus, each of the base flow cross sections illustrated has a shape which is mirror-symmetrical with respect to a centerline L. By way of example, this is shown on an enlarged scale in FIG. 4, which relates to the illustrative embodiment in FIG. 3B. The wall portions 11.1d and 11.2d which are intended to form the recess 11R are then built up in layers in the course of additive manufacture in such a way that each wall portion 11.1d, 11.2d extends at a buildup angle γ≥15° to the centerline L of the cooling duct 11 in the cross-sectional view through the cooling duct 11 and in the direction of view along the direction of extent of the cooling duct 11 as shown in FIGS. 3A to 3C and 4.

During this process, use is made of the fact that—based on the buildup direction BR—the inner duct wall 11d is situated above the outer duct wall 11c during the layered buildup of the combustion chamber shingle 6 on a base plate of a 3-D printer and therefore it is possible to impart to the wall portions 11.1d and 11.2d an inherent stability during the generation of the combustion chamber shingle 6 and thus a self-supporting geometry even during production by specifying an appropriate buildup angle γ.

At the same time, the proposed solution is of course not restricted to a constant (base flow) cross section outside the deflecting region U. For example, a flow cross section can change in the flow direction of the fluid—in this case the cooling air—through the cooling duct 11 from a substantially round cross section with a diameter D to a narrow slot with a width B (in the circumferential direction relative to the correctly installed state in the combustion chamber BK) and a height H (perpendicularly to the inner side IS of the combustion chamber shingle 6 and therefore to the hot side of the combustion chamber BK). B>D and H<D should apply here. In this case, the cross-sectional geometry modified locally by the recess 11R in the deflecting region U is superposed on a corresponding larger-scale change in cross section along the extent of the cooling duct 11.

### LIST OF REFERENCE SIGNS

1 Combustion space
10 Mixing hole/duct
11 (Effusion) cooling hole/duct
11.1d, 11.2d Wall portion
111 Low-pressure compressor
112 High-pressure compressor
113 High-pressure turbine
114 Medium-pressure turbine
115 Low-pressure turbine
11a Inlet opening
11b Outlet opening
11c (Outer) duct wall
11d (Inner) duct wall
11R Recess
2 Fuel nozzle
3 Combustion chamber head
4 Head plate
5 Heat shield (engine component)
6 Combustion chamber shingle (engine component)
7 Combustion chamber wall (engine component)
8 Arm
9 Flange
A Outlet
AS Outer side
B Bypass duct
BK Combustion chamber
BKA Combustion chamber portion
BR Production/buildup direction
C Outlet cone
E Inlet/Intake
F Fan
F1, F2 Fluid flow
FC Fan casing
G Casing
IS Inner side
L Centerline
M Central axis/axis of rotation
PR Powder residues
Ra Inlet direction
Rb Exit direction
Rka, Rkb Direction component
S Rotor shaft
T (Turbofan) engine
TT Turbine
U Deflecting region
Compressor
α Entry angle
β Exit angle
γ Buildup angle
φ Angle

1. An engine component, having at least one cooling duct, which
extends from an inlet opening on a first side of the engine component to an outlet opening on a second side of the engine component through the engine component, wherein fluid flowing into the cooling duct along an inflow direction at the inlet opening can flow out along an outflow direction at the outlet opening, and
has a first, outer duct wall, which lies in the direction of the inflow direction, and a second, inner duct wall, which lies opposite the first, outer duct wall in a cross-sectional view through the engine component and in a direction of view transverse to the inflow and outflow directions,
wherein
the second, inner duct wall has a recess relative to the first, outer duct wall in a region of the cooling duct situated between the inlet opening and the outlet opening, said recess being of V-shaped design in a cross-sectional view through the cooling duct and in a direction of view along a direction of extent of the cooling duct.

2. The engine component according to claim 1, wherein
the at least one cooling duct deflects a fluid flowing in at the inlet opening in a deflecting region along its length in such a way to the outlet opening that the fluid flows out along the outflow direction at the outlet opening with a direction component which is opposite to a direction component of the inflow direction along which the fluid flows into the cooling duct at the inlet opening, and
the second, inner duct wall has the recess relative to the first, outer duct wall in the deflecting region of the cooling duct situated between the inlet opening and the outlet opening, said recess being of V-shaped design in a cross-sectional view through the cooling duct and in a direction of view along a direction of extent of the cooling duct.

3. The engine component according to claim 1, wherein two wall portions of the second, inner duct wall, which define two legs of the V-shaped recess in the cross-sectional view through the cooling duct, enclose between them an angle which is greater than or equal to 60°.

4. The engine component according to claim 3, wherein the two wall portions of the second, inner duct wall enclose between them an angle in a range of from 60 to 150°, in particular in a range of from 70° to 120°, 76° to 110° or 84° to 94°.

5. The engine component according to claim 3, wherein the two wall portions of the second, inner duct wall enclose between them an angle of 90°.

6. The engine component according to claim 1, wherein, in the cross-sectional view through the cooling duct, two wall portions of the second, inner duct wall each define one of two legs of the V-shaped recess, said legs enclosing between them an angle, and, in the cross-sectional view through the cooling duct at least one of the two wall portions extends at a buildup angle greater than or equal to 15° to a centerline of the cooling duct, with respect to which a base flow cross section of the cooling duct, which does not have the recess, is formed in mirror symmetry in the region having the recess.

7. The engine component according to claim 6, wherein at least one of the two wall portions extends at a buildup angle in a range of from 15° to 60°, in particular in a range of from 30° to 55°, 35° to 52° or 43° to 48°, to the centerline in the cross-sectional view through the cooling duct.

8. The engine component according to claim 6, wherein at least one of the two wall portions extends at a buildup angle of 45° to the centerline in the cross-sectional view through the cooling duct.

9. The engine component according to claim 6, wherein the base flow cross section of the cooling duct is circular, oval or rectangular in the region having the recess.

10. The engine component according to claim 2, wherein, in each case based on a mathematically positive direction of rotation, in the cross-sectional view through the engine component and in a direction of view transverse to the inflow and outflow directions, the inflow direction extends at an angle α≥70° to a boundary, bounding the inlet opening, of the first side of the engine component, and a boundary, bounding the outlet opening, of the second side of the engine component extends at an angle β 70° to the outflow direction.

11. The engine component according to claim 1, wherein the engine component is formed by a combustion chamber shingle.

12. A method for the additive manufacture of an engine component having at least one cooling duct, wherein the engine component is built up in layers in a buildup direction with a cooling duct which
extends from an inlet opening on a first side of the engine component to an outlet opening on a second side of the engine component through the engine component, wherein fluid flowing into the cooling duct along an inflow direction at the inlet opening can flow out along an outflow direction at the outlet opening, and
a first, outer duct wall, which lies in the direction of the inflow direction, and a second, inner duct wall, which lies opposite the first, outer duct wall in a cross-sectional view through the engine component and in a direction of view transverse to the buildup direction, is to be produced,
wherein
the second, inner duct wall is formed with a recess relative to the first, outer duct wall in a region of the cooling duct situated between the inlet opening and the outlet opening, said recess being of V-shaped design in a cross-sectional view through the cooling duct and in a direction of view along a direction of extent of the cooling duct.

13. The method according to claim 11, wherein
the cooling duct can deflect a fluid flowing in at the inlet opening in a deflecting region along its length to the outlet opening in such a way that fluid flows out along the outflow direction at the outlet opening with a direction component which is opposite to a direction component of the inflow direction along which the fluid flows into the cooling duct at the inlet opening, and
the second, inner duct wall is formed with the recess relative to the first, outer duct wall in the deflecting region of the cooling duct situated between the inlet opening and the outlet opening, said recess being of V-shaped design in a cross-sectional view through the cooling duct and in a direction of view along a direction of extent of the cooling duct.

14. The method according to claim 12, wherein the wall portions of the second, inner duct wall, which form the recess to be produced, are self-supporting during the buildup of the engine component.

15. The method according to claim 12, wherein the second, inner duct wall is situated above the first, outer duct wall in the buildup direction and, during the additive manufacture of the engine component, is therefore fully built up only after the first, outer duct wall, with the result that, during the additive manufacture of the engine component and based on the buildup direction, a region having the recess on the second, inner duct wall is built up while forming an overhang.

16. The method according to claim 12, wherein a buildup angle is specified which, in a reference plane extending parallel to the buildup direction, is enclosed between a centerline extending transversely to the buildup direction and a wall portion, to be produced, of the second, inner duct wall, which is intended to form one leg of the V-shaped recess in the cross-sectional view through the cooling duct, and the wall portion to be produced is built up in such a way that the wall portion extends at a buildup angle greater than or equal to 15° to the centerline.

17. The method according to claim 12, wherein the engine component to be produced is a combustion chamber shingle.
